(19) United States
(12) Patent Application Publication
(10) Pub. No.: US 2018/0130068 A1
(43) Pub. Date: May 10, 2018

(54) SYSTEM AND METHOD FOR ANALYSING AND EVALUATING CUSTOMER EFFORT

(71) Applicant: SERVIONT GLOBAL SOLUTIONS LIMITED, Chennai (IN)

(72) Inventor: SRIRAM SAMPATH, Chennai (IN)

(21) Appl. No.: 15/803,855

(22) Filed: Nov. 6, 2017

(30) Foreign Application Priority Data
Nov. 6, 2016 (IN) 201641034244

(51) Int. Cl. G06Q 30/00; H04M 3/493; H04M 3/523; G06Q 10/06

(52) U.S. Cl. CPC G06Q 30/01; G06Q 10/06393; H04M 3/523; H04M 3/493

(57) ABSTRACT

A customer effort architecture that estimates customer effort, identifies the friction points and processes leading to excessive customer effort is disclosed. The framework for measuring customer effort using Customer Effort Architecture involves segmenting the KPI's into segments including Cognitive Effort, Time Effort and Emotional Effort. Cognitive effort is the amount of mental energy required to process information. Time effort is the amount of time taken to address the customer requirements. Emotional effort measures psychological parameters experienced by a customer while addressing complaints. The customer effort architecture identifies weights to all the parameters used in calculating effort score, thereby fine tuning the impact each parameter has with respect to the effort score based on business dynamics.

### CROSS-REFERENCE TO RELATED APPLICATIONS

The present application claims the priority of the Indian Provisional Patent Application with serial number 201641034244 filed on Oct. 6, 2016 and subsequently Post-dated by 1 Month to Nov. 6, 2016 with the title, “CUSTOMER EFFORT ARCHITECTURE” and the contents of which is included entirely as reference herein.

### BACKGROUND

### Technical Field

The embodiments herein are generally related to a field of customer relationship management. The embodiments herein are particularly related to a system and method for improving customer experience. The embodiments herein are more particularly related to a system and method for analysing and estimating/evaluating customer effort for enhancing customer experience.

### Description of Related Art

Rapid adoption of internet and other communication technologies have changed the way in which the consumers buy products and services. While e-commerce is convenient for customers and sellers alike, there are certain challenges faced by sellers/service providers for providing an effective, efficient and satisfactory service to their prospective customers effectively.

Sellers and service providers endeavour to serve their customers by providing a unique and satisfying experience. Providing a satisfying experience to the customers is possible when the service providers attempt to analyse the needs of their customers, and the challenges customers go through in their interactions with the service providers. By analysing the customer interactions, the service providers are enabled to improve their customer experience.

Customer effort (CE) measures a degree of effort that the customer has to exert in their interactions with the service provider. These interactions include getting an issue resolved, a request fulfilled, a product purchased/returned, and/or a question answered. In other words, a customer interacts with a service provider to perform a transaction, enquire about a service or complaint about an issue. Customer effort (CE) provides a direct channel to ensure that all customer touch-points and the channels are customer centric in their design and management.

Examples of obstacles in a customer's path in a telecom domain include a complex IVR with many dead end choices, multiple transfers between departments, having to call multiple times to resolve a problem, disregarding preferences or selections made, subjected to switching channel from social, to email, to phone to resolve a problem.

In order to ensure a unified and hassle-free experience, there is a need for a system that estimates customer effort, identifies friction points and processes that lead to excessive customer effort. While customer effort as a number is measured on a scale of 1 to 5, with 1 being the lowest, the design also breaks down the effort, in terms of percentages, into “time effort”, “cognitive effort” and “emotional effort”. This breakdown gives the service provider a very good idea of efforts and emotions undergone by the customer in their interactions. For example, when the customer spends too much time on the website trying to get a payment made to his payee by going back and forth, missing steps, giving incorrect information due to ambiguity, etc. then the efforts of the customer correspond to not just a higher customer effort but also indicate that the “cognitive” part of the effort is a higher percentage when compared to the “time” and “emotional” part of the total customer effort. This analysis helps the service provider to improve his website design, provide more clarity, and the like.

Hence there exists a need for a system and method to analyse and evaluate customer effort in terms of cognitive effort, time effort and emotional effort of customers for enhancing a customer experience for improving performance of service providers.

The above mentioned shortcomings, disadvantages and problems are addressed herein and which will be understood by reading and studying the following specification.

### OBJECTIVES OF THE EMBODIMENTS HEREIN

The primary object of the embodiments herein is to provide a customer effort architecture for analysing a customer effort.

Another object of the embodiments herein is to provide a system and method for analysing and evaluating a customer effort for improving customer experience in service, health and hospitality industries.

Yet another object of the embodiments herein is to provide a system and method to measure a degree of effort exerted by a customer in performing operations such as a transaction, enquiry or a complaint.

Yet another object of the embodiments herein is to provide a system and method to identify weights to all the parameters used in calculating effort score, thereby fine tuning an impact of each parameter with respect to the effort score based on business dynamics.

Yet another object of the embodiments herein is to provide a system and method to provide a break-up of the customer effort in terms of percentage as a measure of “time effort”, “cognitive effort” and “emotional effort”.

Yet another object of the embodiments herein is to provide a system and method to provide a customer effort architecture for computing a customer effort score on a batch mode for each customer.

Yet another object of the embodiments herein is to provide a system and method to measure customer effort based on a plurality of Key Performance Indicators such as Customer effort for the entire life cycle, customer effort for the day, Customer effort loyalty, Customer Effort last transactions, Customer Effort for a specific event, and Customer Efforts at segment levels.

These and other objects and advantages of the embodiments herein will become readily apparent from the following detailed description taken in conjunction with the accompanying drawings.

### SUMMARY

The shortcomings discussed in the background section are addressed by a customer effort architecture that estimates customer effort, identifies the friction points and processes leading to excessive customer effort.

The embodiments herein provide a system and method to analyse and evaluate or estimate a customer effort to improve a customer experience in service industry.

According to an embodiment herein, a method for measuring customer effort score using Customer Effort architecture is provided. The method comprises the following steps. A data is received from a plurality of data sources by a data collector. The received data is stored in a data repository. Pre-defined weights are assigned to the plurality of data sources for calculating customer effort score by an analytics engine. A user defined criteria is assigned to the plurality of data sources by the analytics engine, and wherein the user defined criteria comprises at least one of life cycle, day wise, customer effort on events, customer efforts on loyalty, and customer effort based on last transaction. The plurality of data sources is analysed using pre-set computing scripts and preset rules by the analytics engine. The plurality of data sources is segmented into one of an emotional effort, a time effort and a cognitive effort by the analytics engine. A customer effort score is determined by the analytics engine based on a pre-determined formula and the applied weights.

According to an embodiment herein, the step of analysing the plurality of data sources comprises performing reference level check for the plurality of data sources; normalising each data value from the plurality of data sources to a maximum value and a minimum value; performing time interval spacing for the plurality of data sources; and scaling the plurality of data sources with respect to the reference segments measured on categories comprising region and product.

According to an embodiment herein, the step of segmenting data further comprises segmenting data sources based on at least one of such as age, income, and product revenue.

According to an embodiment herein, the method further comprises storing computed customer effort score in a data repository/storage; and accessing the computed customer effort score from a user interface of an application program.

According to an embodiment herein, the plurality of data sources segmented as cognitive effort comprises voice call per event, Call abandonment at IVR, Call abandonment at ACD, IVR Transfer rate, IVR Disconnect rate, Technical error rate, Menu path confusion rate, Resolution touch-points, Chats per event, Emails per event, Successful chat closure rate, Web query rate, Web error rate, and Interactions per event.

According to an embodiment herein, the plurality of data sources segmented as time effort comprises average IVR talk time, average ACD talk time, average ACD ring time, average ACD hold time, average ACD queue time, average chat wait time, and average mail response time.

According to an embodiment herein, the plurality of data sources segmented as emotional effort comprises call abandonment at IVR, call abandonment at ACD, technical error rate, menu path confusion rate, average ACD hold time, average ACD queue time, forced disconnect rate, ACD Transfer rate, ACD Conference rate, successful chat closure rate, and web error rate.

According to an embodiment herein, a computer system for measuring customer effort score is provided. The system comprises a hardware processor coupled to a memory containing instructions configured for computing customer effort score while using web services; a display screen coupled to the hardware processor for providing a user interface on a computing device; a data collector configured to receive a plurality of data from a plurality of data sources; a data repository configured to store the plurality of data sources; an analytics engine configured to assign pre-defined weights to the plurality of data sources for calculating customer effort score, and wherein the analytics engine is configured to assign user defined criteria to the plurality of data and wherein the analytics engine is configured to analyse the plurality of data sources using pre-set computing scripts, and wherein the analytics engine is configured to segment the plurality of data sources into emotional effort, time effort and cognitive effort by the analytics engine, and wherein the analytics engine is configured to determine customer effort score based on a pre-determined formula and the applied weights.

According to an embodiment herein, the analytics engine is further configured to store computed customer effort score in a data repository/storage; and access the computed customer effort score from a user interface of an application program.

According to an embodiment herein, the analytics engine is further configured to perform reference level check for the plurality of data sources; normalise each data value from the plurality of data sources to a maximum value and a minimum value; perform a time interval spacing for the plurality of data sources; and scale the plurality of data sources with respect to the reference segments measured on categories comprising region and product.

According to an embodiment herein, the analytics engine is further configured to segment data sources based on at least one of such as age, income, and product revenue.

According to an embodiment herein, the plurality of data sources segmented as cognitive effort comprises voice call per event, Call abandonment at IVR, Call abandonment at ACD, IVR Transfer rate, IVR Disconnect rate, Technical error rate, Menu path confusion rate, Resolution touch-points, Chats per event, Emails per event, Successful chat closure rate, Web query rate, Web error rate, and Interactions per event.

According to an embodiment herein, the plurality of data sources segmented as time effort comprises average IVR talk time, average ACD talk time, average ACD ring time, average ACD hold time, average ACD queue time, average chat wait time, and average mail response time.

According to an embodiment herein, the plurality of data sources segmented as emotional effort comprises call abandonment at IVR, call abandonment at ACD, technical error rate, menu path confusion rate, average ACD hold time, average ACD queue time, forced disconnect rate, ACD Transfer rate, ACD Conference rate, successful chat closure rate, and web error rate.

According to an embodiment herein, a computer implemented method comprising instructions stored on a non-transitory computer readable storage medium and are executed on a hard ware processor of a computing device comprising a processor and a memory for measuring customer effort score, is provided. The method comprising the steps of receiving a data from a plurality of data sources by a data collector; storing the received data in a data repository; assigning pre-defined weights to the plurality of data for calculating customer effort score; assigning user defined criteria to the plurality of data sources, and wherein the user defined criteria comprises at least one of life cycle, day wise, customer effort on events, customer efforts on loyalty, and customer effort based on last transaction; analysing the plurality of data sources using pre-set computing scripts; segmenting the plurality of data sources into one of an emotional effort, a time effort and a cognitive effort by the analytics engine; and determining or estimating a customer effort score by the analytics engine based on a pre-determined formula and the applied weights.

According to an embodiment herein, the processor is configured to perform reference level check for the plurality of data sources; normalise each data value from the plurality of data sources to a maximum value and a minimum value; perform time interval spacing for the plurality of data sources; and scale the plurality of data sources with respect to the reference segments measured on categories comprising region and product.

According to an embodiment herein, the step of analysing the plurality of data sources comprises performing reference level check for the plurality of data sources; normalising each data value from the plurality of data sources to a maximum value and a minimum value; performing time interval spacing for the plurality of data sources; and scaling the plurality of data sources with respect to the reference segments measured on categories comprising region and product.

According to an embodiment herein, the step of segmenting data further comprises segmenting data sources based on at least one of such as age, income, and product revenue.

According to an embodiment herein, the method further comprises storing computed customer effort score in a data repository/storage; and accessing the computed customer effort score from a user interface of an application program.

According to an embodiment herein, the plurality of data sources segmented as cognitive effort comprises voice call per event, Call abandonment at IVR, Call abandonment at ACD, IVR Transfer rate, IVR Disconnect rate, Technical error rate, Menu path confusion rate, Resolution touch-points, Chats per event, Emails per event, Successful chat closure rate, Web query rate, Web error rate, and Interactions per event.

According to an embodiment herein, the plurality of data sources segmented as time effort comprises average IVR talk time, average ACD talk time, average ACD ring time, average ACD hold time, average ACD queue time, average chat wait time, and average mail response time.

According to an embodiment herein, the plurality of data sources segmented as emotional effort comprises call abandonment at IVR, call abandonment at ACD, technical error rate, menu path confusion rate, average ACD hold time, average ACD queue time, forced disconnect rate, ACD Transfer rate, ACD Conference rate, successful chat closure rate, and web error rate.

According to an embodiment herein, Key Performance Indicator (KPI) is a measurable value that demonstrates how effectively a company is achieving key business objectives.

According to an embodiment herein, the system comprises a framework for measuring a customer effort using Customer Effort Architecture by segmenting the KPI's into a plurality of segments including Cognitive Effort, Time Effort and Emotional Effort. Cognitive effort is an amount of mental energy required to process information. Examples of cognitive effort include a total number of requests placed to close complaints, and get information. Time effort is an amount of time taken to address the customer requirements. Examples of time effort include waiting time, queue time, etc. Emotional effort measures psychological parameters as a result of an action. Examples of emotional effort include transaction failure, performing repeated actions, being on hold for a long time during a call, etc.

According to an embodiment herein, Customer Effort is a score, measured on all the segments including Cognitive Effort, Time Effort and Emotional Effort, on scale of 1 to 5, where 1 is very low value and 5 is very high value. Scaling and reference segments is the effort metrics computed across various channels are scaled with respect to the reference segments measured on category, sub-category, region, product and sub-product.

According to an embodiment herein, the Customer Efforts calculated using a plurality of KPIs that include Customer Effort life cycle, Customer Effort Day-wise, Customer Effort Events, Customer Effort Aggregated Segment, Customer Effort Last transactions, and Customer Effort Loyalty.

According to an embodiment herein, Customer Effort Life Cycle refers to the holistic view on customer effort as a metric based on all effort driven parameters computed from the date of activation/registration. Customer Effort Life Cycle is updated on a daily basis and further computed from all parameters based on region, category, sub-category, product and sub product. The effort metric is queried on the above mentioned parameters. Region as depicted in the CRM table is considered for Customer Effort calculation. The table considers efforts from all channels such as IVR, ACD, Clickstream, Multimedia, Resolution and Customer Survey.

According to an embodiment herein, Customer Effort at a day wise level are computed based on having one effort per customer per day across all interactions across all channels of interaction. Every customer, who has made some effort on a day will be captured at the category, sub-category, product and sub product level for aforementioned metric. The effort metrics is queried on the same. Region as depicted in the CRM table (originating region) is tracked here. The Customer Effort table considers efforts from all channels such as IVR, ACD, Clickstream, Multimedia, Resolution and Customer Survey.

According to an embodiment herein, Customer Effort Events is registered by each customer such as transaction, inquiry and complaint are tracked. A current event is considered closed either when there is a corresponding data in the event resolution table or when the time period of tracking current events expires (default time period is 7 days which is however configurable). Events are tracked based on category, sub-category, product and sub product categories for a time interval basis. Further, the originating region of the event is tracked here and considered as a base reference. The current event metric is updated at a 2 hour time interval. The timeline on which an event is tracked is kept configurable and varies as per business. The current events table considers efforts from channels such as IVR, ACD and Clickstream.

According to an embodiment herein, Customer Efforts Aggregated Segment is the effort metric on aggregate segments at region, product, sub product, category, sub-category gender, age, and the like. The Segment level table is updated on a daily basis and provides summary metrics at segment levels. The table stores the aggregate effort metrics of the segments and is further used to compute the effort on segments on the fly as per the request.

According to an embodiment herein, the Latest Transactions table captures the last 10 transactions of each customer from all channels. The effort metrics for each transaction (specific to a channel) is computed here.

According to an embodiment herein, Customer Effort Loyalty captures the customer effort across all channels and events (irrespective of category, sub-category, region, product and sub product) per customer till date. The loyalty table shows one value encompassing the 360 degree view of the efforts spent by the customer on the business till date. Further, the effort metrics computed across various effort levels (for example, cognitive, emotional, and the like) and channels (for example, Call centre, Multimedia, and the like) is scaled on a level of one to five with respect to the base reference metric and weighted to arrive at the overall customer effort score.

These and other aspects of the embodiments herein will be better appreciated and understood when considered in conjunction with the following description and the accompanying drawings. It should be understood, however, that the following descriptions, while indicating the preferred embodiments and numerous specific details thereof, are given by way of an illustration and not of a limitation. Many changes and modifications may be made within the scope of the embodiments herein without departing from the spirit thereof, and the embodiments herein include all such modifications.

### BRIEF DESCRIPTION OF THE DRAWINGS

The other objects, features and advantages will occur to those skilled in the art from the following description of the preferred embodiment and the accompanying drawings in which:

FIG. 1 illustrates a block diagram of a customer effort architecture, according to one embodiment herein.

FIGS. 2a and 2b illustrate a flowchart explaining a method of calculating customer effort score, according to one embodiment herein.

FIG. 3 illustrates a block diagram of a system for analysing and evaluating a customer effort, according to one embodiment herein.

FIG. 4 illustrates a screen shot exhibiting a life time score, distribution of a life time customer effort, a life time customer effort by category and average customer effort score estimated with a system for analysing and evaluating a customer effort, according to one embodiment herein.

FIG. 5 illustrates a screen shot exhibiting an average customer effort score by region, an average customer effort score by events, an event wise customer scale, and revenue by customer segment estimated with a system for analysing and evaluating a customer effort, according to one embodiment herein.

Although the specific features of the embodiments herein are shown in some drawings and not in others. This is done for convenience only as each feature may be combined with any or all of the other features in accordance with the embodiments herein.

### DETAILED DESCRIPTION OF THE EMBODIMENTS HEREIN

In the following detailed description, a reference is made to the accompanying drawings that form a part hereof, and in which the specific embodiments that may be practiced is shown by way of illustration. These embodiments are described in sufficient detail to enable those skilled in the art to practice the embodiments and it is to be understood that the logical, mechanical and other changes may be made without departing from the scope of the embodiments. The following detailed description is therefore not to be taken in a limiting sense.

The various embodiments of the embodiments herein provide a customer effort architecture that estimates customer effort, and identifies friction points and processes leading to excessive customer effort. The customer effort architecture measures the degree of effort a customer has to exert in order to perform operations such as a transaction, enquiry or a complaint. Further, the embodiments herein identifies weights to all the parameters used in calculating effort score, thereby fine tuning the impact each parameter has with respect to the effort score based on business dynamics. The embodiments herein provides a break-up of the customer effort in terms of percentage as a measure of “time effort”, “cognitive effort” and “emotional effort”.

According to an embodiment herein, a method for measuring customer effort score using Customer Effort architecture is provided. The method comprises the following steps. A data is received from a plurality of data sources by a data collector. The received data is stored in a data repository. Pre-defined weights are assigned to the plurality of data sources for calculating customer effort score by an analytics engine. A user defined criteria is assigned to the plurality of data sources by the analytics engine, and wherein the user defined criteria comprises at least one of life cycle, day wise, customer effort on events, customer efforts on loyalty, and customer effort based on last transaction. The plurality of data sources is analysed using pre-set computing scripts and preset rules by the analytics engine. The plurality of data sources is segmented into one of an emotional effort, a time effort and a cognitive effort by the analytics engine. A customer effort score is determined by the analytics engine based on a pre-determined formula and the applied weights.

According to an embodiment herein, the step of analysing the plurality of data sources comprises performing reference level check for the plurality of data sources; normalising each data value from the plurality of data sources to a maximum value and a minimum value; performing time interval spacing for the plurality of data sources; and scaling the plurality of data sources with respect to the reference segments measured on categories comprising region and product.

According to an embodiment herein, the step of segmenting data further comprises segmenting data sources based on at least one of such as age, income, and product revenue.

According to an embodiment herein, the method further comprises storing computed customer effort score in a data repository/storage; and accessing the computed customer effort score from a user interface of an application program.

According to an embodiment herein, the plurality of data sources segmented as cognitive effort comprises voice call per event, Call abandonment at IVR, Call abandonment at ACD, IVR Transfer rate, IVR Disconnect rate, Technical error rate, Menu path confusion rate, Resolution touch-points, Chats per event, Emails per event, Successful chat closure rate, Web query rate, Web error rate, and Interactions per event.

According to an embodiment herein, the plurality of data sources segmented as time effort comprises average IVR talk time, average ACD talk time, average ACD ring time, average ACD hold time, average ACD queue time, average chat wait time, and average mail response time.

According to an embodiment herein, the plurality of data sources segmented as emotional effort comprises call abandonment at IVR, call abandonment at ACD, technical error rate, menu path confusion rate, average ACD hold time, average ACD queue time, forced disconnect rate, ACD Transfer rate, ACD Conference rate, successful chat closure rate, and web error rate.

According to an embodiment herein, a computer system for measuring customer effort score is provided. The system comprises a hardware processor coupled to a memory containing instructions configured for computing customer effort score while using web services; a display screen coupled to the hardware processor for providing a user interface on a computing device; a data collector configured to receive a plurality of data from a plurality of data sources; a data repository configured to store the plurality of data sources; an analytics engine configured to assign pre-defined weights to the plurality of data sources for calculating customer effort score, and wherein the analytics engine is configured to assign user defined criteria to the plurality of data and wherein the analytics engine is configured to analyse the plurality of data sources using pre-set computing scripts, and wherein the analytics engine is configured to segment the plurality of data sources into emotional effort, time effort and cognitive effort by the analytics engine, and wherein the analytics engine is configured to determine customer effort score based on a pre-determined formula and the applied weights.

According to an embodiment herein, the analytics engine is further configured to store computed customer effort score in a data repository/storage; and access the computed customer effort score from a user interface of an application program.

According to an embodiment herein, the analytics engine is further configured to perform reference level check for the plurality of data sources; normalise each data value from the plurality of data sources to a maximum value and a minimum value; perform a time interval spacing for the plurality of data sources; and scale the plurality of data sources with respect to the reference segments measured on categories comprising region and product.

According to an embodiment herein, the analytics engine is further configured to segment data sources based on at least one of such as age, income, and product revenue.

According to an embodiment herein, the plurality of data sources segmented as cognitive effort comprises voice call per event, Call abandonment at IVR, Call abandonment at ACD, IVR Transfer rate, IVR Disconnect rate, Technical error rate, Menu path confusion rate, Resolution touch-points, Chats per event, Emails per event, Successful chat closure rate, Web query rate, Web error rate, and Interactions per event.

According to an embodiment herein, the plurality of data sources segmented as time effort comprises average IVR talk time, average ACD talk time, average ACD ring time, average ACD hold time, average ACD queue time, average chat wait time, and average mail response time.

According to an embodiment herein, the plurality of data sources segmented as emotional effort comprises call abandonment at IVR, call abandonment at ACD, technical error rate, menu path confusion rate, average ACD hold time, average ACD queue time, forced disconnect rate, ACD Transfer rate, ACD Conference rate, successful chat closure rate, and web error rate.

According to an embodiment herein, a computer implemented method comprising instructions stored on a non-transitory computer readable storage medium and are executed on a hard ware processor of a computing device comprising a processor and a memory for measuring customer effort score, is provided. The method comprising the steps of receiving a data from a plurality of data sources by a data collector; storing the received data in a data repository; assigning pre-defined weights to the plurality of data for calculating customer effort score; assigning user defined criteria to the plurality of data sources, and wherein the user defined criteria comprises at least one of life cycle, day wise, customer effort on events, customer efforts on loyalty, and customer effort based on last transaction; analysing the plurality of data sources using pre-set computing scripts; segmenting the plurality of data sources into one of an emotional effort, a time effort and a cognitive effort by the analytics engine; and determining or estimating a customer effort score by the analytics engine based on a pre-determined formula and the applied weights.

According to an embodiment herein, the processor is configured to perform reference level check for the plurality of data sources; normalise each data value from the plurality of data sources to a maximum value and a minimum value; perform time interval spacing for the plurality of data sources; and scale the plurality of data sources with respect to the reference segments measured on categories comprising region and product.

According to an embodiment herein, the step of analysing the plurality of data sources comprises performing reference level check for the plurality of data sources; normalising each data value from the plurality of data sources to a maximum value and a minimum value; performing time interval spacing for the plurality of data sources; and scaling the plurality of data sources with respect to the reference segments measured on categories comprising region and product.

According to an embodiment herein, the step of segmenting data further comprises segmenting data sources based on at least one of such as age, income, and product revenue.

According to an embodiment herein, the method further comprises storing computed customer effort score in a data repository/storage; and accessing the computed customer effort score from a user interface of an application program.

According to an embodiment herein, the plurality of data sources segmented as cognitive effort comprises voice call per event, Call abandonment at IVR, Call abandonment at ACD, IVR Transfer rate, IVR Disconnect rate, Technical error rate, Menu path confusion rate, Resolution touch-points, Chats per event, Emails per event, Successful chat closure rate, Web query rate, Web error rate, and Interactions per event.

According to an embodiment herein, the plurality of data sources segmented as time effort comprises average IVR talk time, average ACD talk time, average ACD ring time, average ACD hold time, average ACD queue time, average chat wait time, and average mail response time.

According to an embodiment herein, the plurality of data sources segmented as emotional effort comprises call abandonment at IVR, call abandonment at ACD, technical error rate, menu path confusion rate, average ACD hold time, average ACD queue time, forced disconnect rate, ACD Transfer rate, ACD Conference rate, successful chat closure rate, and web error rate.

According to an embodiment herein, the framework for measuring customer effort using Customer Effort Architecture involves segmenting the KPI's into segments including Cognitive Effort, Time Effort and Emotional Effort. Cognitive effort is the amount of mental energy required to process information. Examples of cognitive effort include a total number of requests placed to close complaints, and get information. Time effort is the amount of time taken to address the customer requirements. Examples of time effort include waiting time, queue time, etc. Emotional effort measures psychological parameters as a result of an action. Examples of emotional effort include transaction failure, performing repeated actions, being on hold for a long time during a call, etc.

According to an embodiment herein, Customer Effort is a score, measured on all the segments including Cognitive Effort, Time Effort and Emotional Effort, on scale of 1 to 5, where 1 is very low value and 5 is very high value. Scaling and reference segments is the effort metrics computed across various channels are scaled with respect to the reference segments measured on category, sub-category, region, product and sub-product.

According to an embodiment herein, the Customer Efforts calculated using a plurality of KPI include Customer Effort life cycle, Customer Effort Day-wise, Customer Effort Events, Customer Effort Aggregated Segment, Customer Effort Last transactions, and Customer Effort Loyalty.

According to an embodiment herein, Customer Effort Life Cycle refers to the holistic view on customer effort as a metric based on all effort driven parameters computed from the date of activation/registration. Customer Effort Life Cycle is updated on a daily basis and further computed from all parameters based on region, category, sub-category, product and sub product. The effort metric is queried on the above mentioned parameters. Region as depicted in the CRM table is considered for Customer Effort calculation. The table considers efforts from all channels such as IVR, ACD, Clickstream, Multimedia, Resolution and Customer Survey.

According to an embodiment herein, Customer Effort at a day wise level are computed based on having one effort per customer per day across all interactions across all channels of interaction. Every customer, who has made some effort on a day will be captured at the category, sub-category, product and sub product level for aforementioned metric. The effort metrics is queried on the same. Region as depicted in the CRM table (originating region) is tracked here. The Customer Effort table considers efforts from all channels such as IVR, ACD, Clickstream, Multimedia, Resolution and Customer Survey.

According to an embodiment herein, Customer Effort Events is registered by each customer such as transaction, inquiry and complaint are tracked. A current event is considered closed either when there is a corresponding data in the event resolution table or when the time period of tracking current events expires (default time period is 7 days which is however configurable). Events are tracked based on category, sub-category, product and sub product categories for a time interval basis. Further, the originating region of the event is tracked here and considered as a base reference. The current event metric is updated at a 2 hour time interval. The timeline on which an event is tracked is kept configurable and varies as per business. The current events table considers efforts from channels such as IVR, ACD and Clickstream.

According to an embodiment herein, Customer Efforts Aggregated Segment is the effort metric on aggregate segments at region, product, sub product, category, sub-category gender, age, and the like. The Segment level table is updated on a daily basis and provides summary metrics at segment levels. The table stores the aggregate effort metrics of the segments and is further used to compute the effort on segments on the fly as per the request.

The Latest Transactions table captures the last 10 transactions of each customer from all channels. The effort metrics for each transaction (specific to a channel) is computed here.

According to an embodiment herein, Customer Effort Loyalty captures the customer effort across all channels and events (irrespective of category, sub-category, region, product and sub product) per customer till date. The loyalty table shows one value encompassing the 360 degree view of the efforts spent by the customer on the business till date. Further, the effort metrics computed across various effort levels (for example, cognitive, emotional, and the like) and channels (for example, Call centre, Multimedia, and the like) is scaled on a level of one to five with respect to the base reference metric and weighted to arrive at the overall customer effort score.

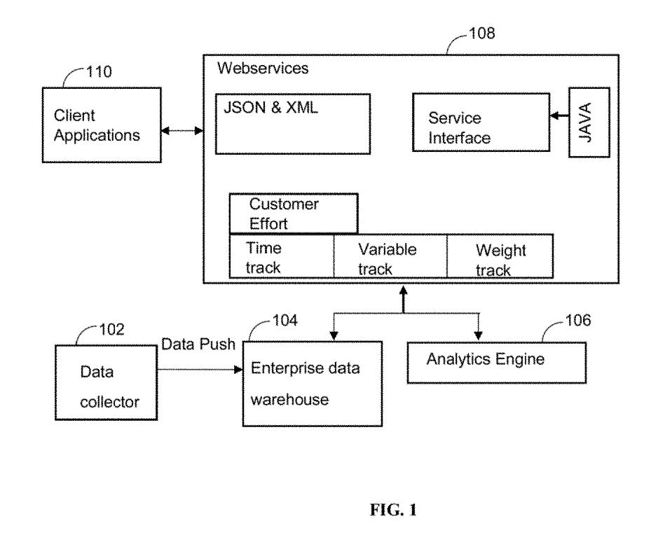

FIG. 1 is a block diagram illustrating a customer effort architecture, according to one embodiment of the embodiments herein. The framework for measuring customer effort using Customer Effort Architecture involves segmenting the KPI's into segments including Cognitive Effort, Time Effort, Emotional Effort, and Customer Effort. Cognitive effort is the amount of mental energy required to process information. Examples of cognitive effort include a total number of requests placed to close complaints, and get information. Time effort is the amount of time taken to address the customer requirements. Examples of time effort include waiting time, queuing time, and the like. Emotional effort measures psychological parameters experienced by a customer while addressing complaints. Examples of emotional effort include problems with staff, failure in technology, and number of escalations made to address complaints.

According to an embodiment herein, Customer Effort is a score, measured on all the segments including Cognitive Effort, Time Effort, and Emotional Effort, on a scale of one to five, where value ‘one’ indicates a low CE score and 5 indicates a high CE score. The effort is calculated based on interactions a customer has per event. Scaling and reference segments is the effort metrics computed across various channels are scaled with respect to the reference segments measured on two fields which are region and product. Apart from region and product, category, sub products are considered as parameters in CE calculation. According to an embodiment of the embodiments herein, effort metric is scaled at a global level to deduce customer effort in the absence of region or product fields.

According to an embodiment herein, the Customer Efforts calculated using a plurality of KPI include Customer Effort life cycle, Customer Effort Day-wise, Customer Effort Events, Customer Effort Aggregated Segment, Customer Effort Last transactions, and Customer Effort Loyalty. Customer Effort Life Cycle refers to the holistic view on customer effort as a metric based on all effort driven parameters computed from the date of activation/registration. Customer Effort Life Cycle is updated on a daily basis and further computed from all parameters based on region, category, sub-category, product and sub product. The effort metric is queried on the above mentioned parameters. Region as depicted in the CRM table is considered for Customer Effort calculation. The table considers efforts from all channels such as IVR, ACD, Clickstream, Multimedia, Resolution and Customer Survey.

According to an embodiment herein, Customer Effort at a day wise level are computed based on having one effort per customer per day across all interactions across all channels of interaction. Every customer, who has made some effort on a day will be captured at the category, sub-category, product and sub product level for aforementioned metric. The effort metrics is queried on the same. Region as depicted in the CRM table (originating region) is tracked here. The Customer Effort table considers efforts from all channels such as IVR, ACD, Clickstream, Multimedia, Resolution and Customer Survey.

According to an embodiment herein, Customer Effort Events is registered by each customer such as transaction, inquiry and complaint are tracked. A current event is considered closed either when there is a corresponding data in the event resolution table or when the time period of tracking current events expires (default time period is 7 days which is however configurable). Events are tracked based on category, sub-category, product and sub product categories for a time interval basis. Further, the originating region of the event is tracked here and considered as a base reference. The current event metric is updated at a 2 hour time interval. The timeline on which an event is tracked is kept configurable and varies as per business. The current events table considers efforts from channels such as IVR, ACD and Clickstream.

According to an embodiment herein, Customer Efforts Aggregated Segment is the effort metric on aggregate segments at region, product, sub product, category, sub-category gender, age, and the like. The Segment level table is updated on a daily basis and provides summary metrics at segment levels. The table stores the aggregate effort metrics of the segments and is further used to compute the effort on segments on the fly as per the request.

The Latest Transactions table captures the last 10 transactions of each customer from all channels. The effort metrics for each transaction (specific to a channel) is computed here.

According to an embodiment herein, Customer Effort Loyalty captures the customer effort across all channels and events (irrespective of category, sub-category, region, product and sub product) per customer till date. The loyalty table shows one value encompassing the 360 degree view of the efforts spent by the customer on the business till date. Further, the effort metrics computed across various effort levels (for example, cognitive, emotional, and the like) and channels (for example, Call centre, Multimedia, and the like) is scaled on a level of one to five with respect to the base reference metric and weighted to arrive at the overall customer effort score.

With respect to FIG. 1, data sources 102 is utilised for computing Customer Effort metrics. Enterprise Data Warehouse 104 performs data extraction and transformation process using tools, for example Sqoop and Flume. The CE application utilises transaction and aggregate tables elaborated in TABLE 1. Analytics Engine computes the parameters, metrics R and Python in the TABLE 1 that are specific to Customer Effort Application.

TABLE 1

| Analytical | | | | Time |
|---|---|---|---|---|
| Table | Description | Insights | Storage | Interval |
| Customer | The table captures overall | Customer Efforts at | PostgreSQL | 24 hours |
| Efforts - Life | effort metrics of the | Customer ID level, | | |
| Cycle | customer specific to region, | region, category, | | |
| (ce_lifecycle) | category, product and sub | product and sub | | |
| | product till date. | product till date are to | | |
| | | be queried from this | | |
| | | table. | | |
| Customer | The table tracks customer | Trend on Customer | PostgreSQL | 24 hours |
| Efforts - Day | efforts specific to category, | Efforts day wise, on | | |
| wise | product and sub product | region, category, | | |
| (ce_daywise) | categories on a date wise | product, and sub | | |
| | basis. The table stores time | product, comparison | | |
| | trend information of the | of effort metrics over | | |
| | effort metrics at the | time periods, etc at | | |
| | customer and category, | Customer ID level are | | |
| | product and sub product | to be queried from this | | |
| | level. This table will show | table. | | |
| | the efforts made by a | | | |
| | customer for that day on the | | | |
| | events performed per day. | | | |
| Customer | The table captures effort | Customer Efforts on | PostgreSQL | 2 hours |
| Efforts - | metrics per customer ID at | recent events at | | |
| Events | the category, product and | Customer ID level are | | |
| (ce_events) | sub product event level. This | to be queried from this | | |
| | table would track and tie | table. | | |
| | customer events dated to the | | | |
| | configured time period and | | | |
| | measure efforts from it. This | | | |
| | table would only capture the | | | |
| | effort of a customer at the | | | |
| | event level dated to a 7 day | | | |
| | period. | | | |
| Customer | The table captures customer | Summary measures on | PostgreSQL | 24 hours |
| Efforts - | efforts at segment levels like | customer efforts at | | |
| Aggregate | region, gender, age bucket, | segment levels such as | | |
| Segments | Product revenue bucket, etc. | region, city, gender, | | |
| (CE_AggSeg) | The information present here | age, etc over time | | |
| | would track the aggregated | periods are to be | | |
| | efforts at overall segment | queried from this | | |
| | levels on a day wise basis. | table. | | |
| CE event - | The table provides base | The base reference | PostgreSQL | 2 hours |
| Time base | reference values considered | values considered for | | |
| reference | for all effort metrics at the | scaling the event effort | | |
| (ce_events_ref) | region and product level. | metrics can be | | |
| | These values would be used | retrieved from this | | |
| | as the base for scaling the | table. This table would | | |
| | effort metrics at the | provide the values for | | |
| | customer level. These base | comparison. | | |
| | reference values will be | | | |
| | calculated based on a | | | |
| | manual sampling exercise | | | |
| | for every customer | | | |
| CE Daywise - | The table provides base | The base reference | PostgreSQL | 24 hours |
| Base reference | reference values considered | values considered for | | |
| (ce_daywise_ref) | for all day wise effort | scaling the day wise | | |
| | metrics at the region product | effort metrics can be | | |
| | and sub product level. These | retrieved from this | | |
| | values would be used as the | table. This table would | | |
| | base for scaling the effort | provide the values for | | |
| | metrics at the customer | comparison. | | |
| | level. These base reference | | | |
| | values will be calculated | | | |
| | based on a manual sampling | | | |
| | exercise for every customer | | | |
| CE - Last | The table captures last 10 | The latest transaction | PostgreSQL | 2 hours |
| transactions | transactions performed by | level effort spent by | | |
| (ce_transaction) | each and every customer and | the customer can be | | |
| | their corresponding effort | queried here. | | |
| | metrics. | | | |
| CE - Loyalty | The table captures the CE | 360 degree view of the | PostgreSQL | 24 hours |
| (ce_loyalty) | score per customer across all | customer efforts | | |
| | categories, products and sub | across all categories, | | |
| | products till date. | products and sub | | |
| | | products till date can | | |
| | | be queried here. | | |

Web services 108 computes configurable parameters such as Time track, weight track, and Variable track. Time track allows the web service 108 to configure the time period on which the effort metrics are to be tracked and mapped with. Time track is defined on qualified business rules. Insights time track is the time interval at which the CE parameters are updated as illustrated in TABLE 2.

TABLE 2

| | | Default |
|---|---|---|
| Insights Tables | Table Name | Time Interval |
| Customer Efforts - Life Cycle | ce_lifecycle | 24 hours |
| Customer Efforts - Day wise | ce_daywise | 24 hours |
| Customer Efforts - Events | ce_events | 2 hours |
| CE event - Time base reference | ce_events_ref | 2 hours |
| CE Daywise - Base reference | ce_daywise_ref | 24 hours |
| CE Last Transactions | ce_transaction | 2 hours |
| CE Loyalty | ce_loyalty | 24 hours |

According to an embodiment herein, the rules to be followed while setting time intervals for insights table listed in Table 2 are as follows:

a) ce_events—The time interval for this table must always be less than the ce_daywise time interval.

b) ce_daywise—ce_daywise is typically set as 24 hours.

c) ce_lifecycle—The table is derived from ce_daywise. Hence the time interval is greater than or equal to the day wise time interval.

d) ce_loyalty—The table is derived from ce_lifecycle. Hence the time interval is greater than or equal to the lifecycle time interval.

e) ce_transaction—The time interval is typically similar to the events table.

f) ce_daywise_ref—This table follows the same time interval from ce_daywise.

g) ce_events_ref—The table follows the same time interval from ce_events.

According to an embodiment herein, Closure period track is the time interval at which an effort (interaction of category, product and sub product) is tracked as the same in the absence of a closure at the Customer ID level can be configured here. For examples if the closure period is 7 days, in this case the disassociation period between two same events for a customer ID is 7 days or more, the second event is considered as a new one.

Variable Track parameter allows a service to modify the variables that is used in the computation of the effort metrics. The variables that are used in the algorithm development are outlined in the TABLE 3. The weights used for the effort metrics (Weight track) in the final Customer Efforts Score is configured. The KPI's defined for the algorithm and the subsequent weights used are illustrated in TABLE 3.

TABLE 3

| | | | Effort | Channel | |
|---|---|---|---|---|---|
| No | Final KPI′ | Definitions | Type | Type | Inference |
| 1 | Voice Calls | Number of calls received | Cognitive | IVR | Higher the no. Of |
| | per event | for the event | effort | | calls per event, higher |
| | | | | | the effort |
| 2 | Call | No. of calls | Cognitive | IVR | The metric would |
| | abandonment | abandoned/Total no. Of | effort & | | range from 0 to 1. |
| | at IVR | IVR calls made | Emotional | | The closer it is to 1, |
| | | | effort | | the more the efforts. |
| 3 | Call | No. of calls abandoned/ | Cognitive | ACD | The metric would |
| | abandonment | Total no. Of ACD calls | effort & | | range from 0 to 1. |
| | at ACD | made | Emotional | | The closer it is to 1, |
| | | | effort | | the more the efforts. |
| 4 | IVR | No. of calls transferred to | Cognitive | IVR | The metric would |
| | Transfer rate | ACD/Total no. Of IVR | effort | | range from 0 to 1. |
| | | Calls | | | The closer it is to 1, |
| | | | | | the more the efforts. |
| 5 | Avg. IVR | Total time spent from all | Time effort | IVR | Higher the amount of |
| | talk time | IVR calls/No. Of IVR | | | time, greater the |
| | | calls made | | | efforts. |
| 6 | Avg. ACD | Total talk time spent from | Time effort | ACD | Higher the amount of |
| | talk time | all ACD calls/No. Of | | | time, greater the |
| | | ACD calls made | | | efforts. |
| 7 | IVR | No. of calls disconnected | Cognitive | IVR | This metric would |
| | Disconnect | by IVR/Total no. Of IVR | effort | | range from 0 to 1. |
| | rate | calls made | | | The closer the metric |
| | | | | | is to 1, the greater the |
| | | | | | service containment. |
| | | | | | This metric to be |
| | | | | | qualified along with |
| | | | | | business rules. |
| 8 | Technical | No. of calls down by | Cognitive | IVR | The metric would |
| | error rate | linked down error/Total | effort & | | range from 0 to 1. |
| | | no. Of IVR calls made | Emotional | | The closer it is to 1, |
| | | | effort | | the more the efforts. |
| 9 | Menu path | No. of menu path repeats | Cognitive | IVR | The greater the |
| | confusion | in same call | effort & | | number, the higher |
| | rate | | Emotional | | the efforts and |
| | | | effort | | confusion. |
| 10 | Avg ACD | Total ring time of all | Time effort | ACD | Higher the amount of |
| | ring time | calls/No. Of ACD calls | | | time, greater the |
| | | | | | efforts. |
| 11 | Avg ACD | Total hold time on all | Time effort | ACD | Higher the amount of |
| | hold time | calls/No. Of ACD calls | & | | time, greater the |
| | | | Emotional | | emotional strain and |
| | | | effort | | time effort |
| 12 | Avg ACD | Total queue time on all | Time effort | ACD | Higher the amount of |
| | queue time | calls/No. Of ACD calls | & | | time, greater the |
| | | | Emotional | | emotional strain and |
| | | | effort | | time effort |
| 13 | Forced | No. of forced disconnect | Emotional | ACD | The metric would |
| | disconnect | calls/Total no. Of ACD | effort | | range from 0 to 1. |
| | rate | calls made | | | The closer it is to 1, |
| | | | | | the more emotional |
| | | | | | frustration. |
| 14 | ACD | No. of transferred | Emotional | ACD | The metric would |
| | Transfer rate | calls/Total no. of ACD | effort | | range from 0 to 1. |
| | | Calls | | | The closer it is to 1, |
| | | | | | the more emotional |
| | | | | | frustration. |
| 15 | ACD | No. of conference calls | Emotional | ACD | The metric would |
| | Conference | made/Total no. Of ACD | effort | | range from 0 to 1. |
| | rate | calls | | | The closer it is to 1, |
| | | | | | the more emotional |
| | | | | | frustration. |
| 16 | Resolution | No. of days taken to close | Efficiency | Resolution | Higher the number, |
| | Age | the ticket | metric | | greater the resolution |
| | | | | | time. This metric to |
| | | | | | be benchmarked |
| | | | | | against values. |
| 17 | Resolution | Whether received timely | Efficiency | Resolution | 0 or 1. This metric to |
| | effectiveness | response fort ticket | metric | | be benchmarked |
| | | | | | against values |
| 18 | Resolution | Count of unique touch- | Cognitive | IVR, ACD, | The greater the |
| | touch-points | points on ticket | effort | Multimedia | number, the higher |
| | | | | | the efforts. This |
| | | | | | metric to be |
| | | | | | benchmarked against |
| | | | | | values |
| 19 | Chats per | No. of chats recorded for | Cognitive | Multimedia | The greater the |
| | event | the event | effort | | number, the higher |
| | | | | | the efforts. |
| 20 | Emails per | No. of emails recorded | Cognitive | Multimedia | The greater the |
| | event | for the event | effort | | number, the higher |
| | | | | | the efforts. |
| 21 | Successful | No. of chats that ended in | Cognitive | Multimedia | Metric would range |
| | chat closure | successful closure/No. Of | effort & | | between 0 to 1. The |
| | rate | chats for the event | Emotional | | closure the metric is |
| | | | effort | | to 1, the better the |
| | | | | | efficiency and less |
| | | | | | emotional efforts |
| 22 | Avg chat | Total of chat wait | Time effort | Multimedia | Higher the amount of |
| | wait time | time/No. Of chats per | | | time, greater the |
| | | event | | | efforts. |
| 23 | Avg mail | Total of mail response | Time effort | Multimedia | Higher the amount of |
| | response | time/No. Of mails per | | | time, greater the |
| | time | event | | | efforts. |
| 24 | CSAT score | Survey score on customer | Efficiency | CSAT | Higher the score, |
| | on efforts | efforts | metric | | greater the efforts (as |
| | | | | | per scale) |
| 25 | Web query | No. of times a web query | Cognitive | Clickstream | Higher the number, |
| | rate | was made on the event | effort | | greater the efforts. |
| 26 | Web error | No. of times a web error | Cognitive | Clickstream | The metric would |
| | rate | was received while | effort & | | range from 0 to 1. |
| | | browsing the event | Emotional | | The closer it is to 1, |
| | | | effort | | the more emotional |
| | | | | | frustration. |
| 27 | Interactions | No. of interactions across | Cognitive | Multi | Higher the no. of |
| | per event | all channels made for the | | channel | interactions, higher |
| | | event | | | the effort |

According to an embodiment herein, the KPI's listed in TABLE 3 are scaled as per the weights set on the application. The weights set across each KPI parameters sums to 100%. The ideal weights to be set on KPI's is updated by the CE application. Further, KPI parameters are configured by the business as per needs. For example, the weights are assumed to be 3.07% for all KPI's to sum to 100. The scaling of the variables are currently considered at +0.75, +0.25, −0.25 and −0.75 levels. The scaling of the variables is determined from the initial sampling of the data and varies from customer to customer. The scales changes as per the dynamicity of the data. The scales are further determined from the cross validation of certain metrics (which needs to be identified) that are qualifiers on the actual performance of the CE application. The segmentation variables at which the base reference metrics would be computed are Region and Product. The clickstream KPIs are referenced against the product level only while all other set of KPIs are referenced against the region and product type.

According to an embodiment herein, the variables captured along with the customer IDs and used for computing aggregate segment measures include period, region, category, product, sub-product, age bucket, gender and customer tenure bucket.

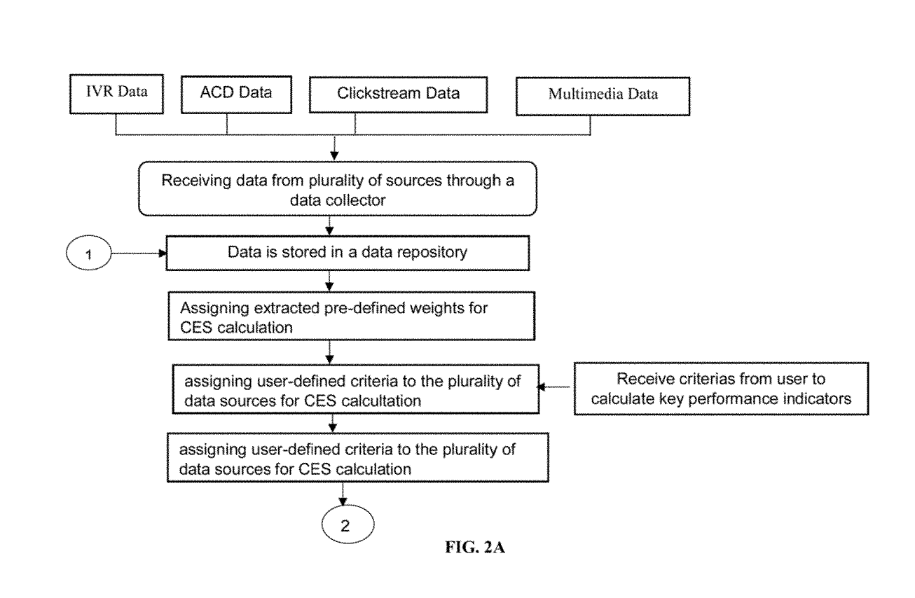

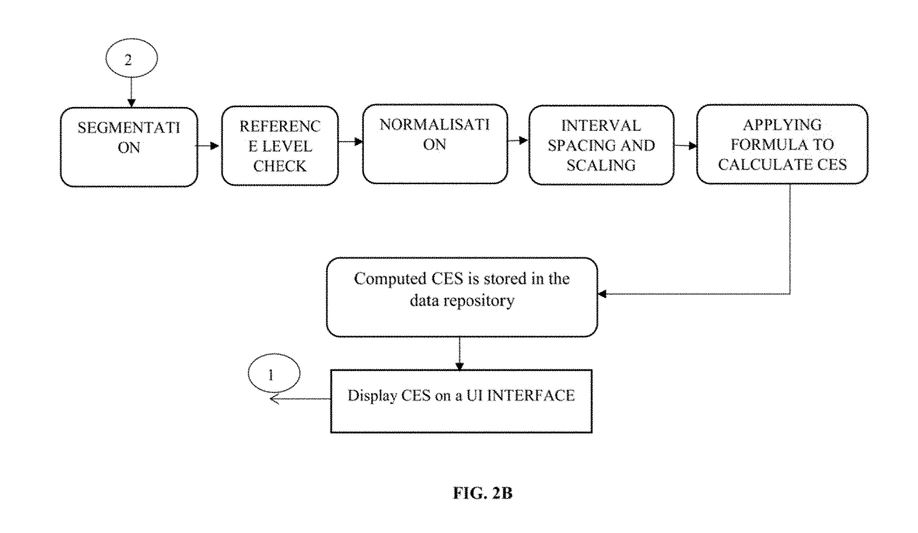

FIG. 2a and 2b is a flowchart illustrating the method of calculating customer effort score. The collector receives data from a plurality of data sources. The data sources include Call Centre Data-IVR, Call Centre Data-ACD, CRM Data, Resolution Data, Multimedia Data, Customer Survey Data, Product Renewal Data, Clickstream Data, and Campaign Data.

According to an embodiment herein, data from various data bases is extracted and processed using Flume and Sqoop. The processed transaction data would be stored at HDFS and PostgreSQL as per the below storage at the application schema level. The client data base can be any RDBMS or flat file from which the connectivity would be established through ODBC drivers (RDBMS) and Flume (flat files) for the application. In the applications built in this project, the client database is assumed to be MySQL (RDBMS) for all data sources except Clickstream where they are log files. Thereafter, analytical processing of transactional data is performed using ‘R’ script. The effort metrics computed across various channels are scaled with respect to the reference segments measured on two fields which are region and product. The segmentation variables at which the base reference metrics would be computed are based on Region, and Product. The clickstream KPIs are referenced against the product level only while all other set of KPIs are referenced against the region and product type. Subsequently, the effort metrics computed across various channels are scaled with respect to the reference segments measured on two fields which are region and product. Thus, the customer effort score is calculated based on all the above metrics on scale of 1 to 5, where 1 is very low and 5 is very high. The effort is calculated based on interactions a customer has per event.

According to an embodiment herein, the data ingestion time configuration for all sources/channels/tables used in SAIL applications are defined as below. The ingestion time period for all applications can be configured through RESTFUL services. The REST API on ingestion time track allows for all set/get/put/delete methods on for configuring the time intervals for all data sources (Refer Generic API Documentation for details). The ingestion time interval is only set on the schema at the enterprise source level as these table ingestions must derive the time interval setting logic from the business. The time interval must be set for the below table 4. The table 4 ingested from enterprise are stored at the HDFS/PostgreSQL layer on SAIL side. The REST APIs are configured to set the time intervals at the enterprise source level.

TABLE 4

| No. | Data tables | Default Time Interval |
|---|---|---|
| 1 | enterprise_ivr | 2 hours |
| 2 | enterprise_acd | 2 hours |
| 3 | enterprise_crmdata | 24 hours |
| 4 | enterprise_multimedia | 24 hours |
| 5 | enterprise_resolution | 24 hours |
| 6 | enterprise_csat | 24 hours |
| 7 | enterprise_product_renewal | 24 hours |
| 8 | enterprise_clickstream | 2 hours |

The SAIL applications is further customized by each customer by adding their own specifications. The applications are made customizable through the configuration APIs provided by the applications. This section outlines the configuration tables used by the applications and their structured. Apart from the below generic configuration tables, each application will also have application specific tables based on the level of customizations provided.

According to an embodiment herein, the Time Track (sail_insights.time_track)—allows the service to configure the time period on which all insight tables from the applications are to be tracked and mapped. The tables configured here would be updated based on the time track information present in these tables. This has to evolve from the business rules identified. The APIs would refer to the configurations maintained in this table for necessary table updates.

According to an embodiment herein, the Period Track (sail_insights.period_track) is the time interval at which the insight tables from the applications should be stored in the tables are configured here. All data beyond the configurable period will be deleted from the tables. For e.g. if the period track per table is maintained as 6 months, each table will hold data only for the past 6 months. Data older than that would be deleted from their respective tables. These are configurable through APIs and can be decided by the business based on the data size and system configuration.

According to an embodiment herein, the weight Track (sail_insights. weight_track) configuration parameter allows business users to add/edit/delete weights provided for the KPIs defined in the applications. The weights that needs to be configured must evolve from business rules. This table also stores the mapping information for each KPI in applications to refer to. The mapping APIs refer to the information provided in this table to map variables from client data sources to underlying KPIs.

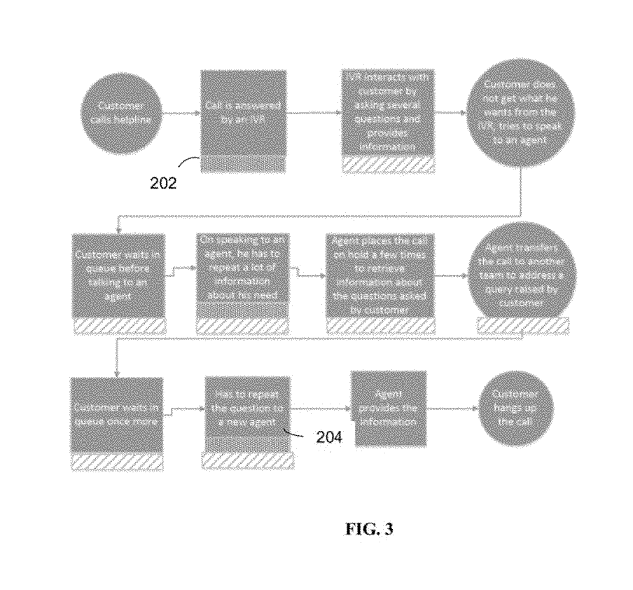

FIG. 3 is a block diagram illustrating an exemplary embodiment of the embodiments herein. FIG. 3 illustrates an exemplary scenario of an e-commerce website depicting customer journey while customer places a call regarding a query/complaint. The touch points/interaction points are indicated in 202, and points of higher effort/friction points are indicated by 204. If tools and processes do not exist to support the interaction point, they are noted as ‘Friction Points’ or points of higher effort 204. For example, customer places a call with a helpline, and the call is answered by an IVR (touch point). Further, the IVR interacts with the customer by asking several questions and provides related information (friction point). Once the customer is dissatisfied with the information provided by the IVR, the customer attempts to speak to an agent. The customer waits in queue to start conversation with the agent (friction point). While speaking to the agent, the customer has to repeat information about his requirements (friction point). Further, the agent places the call on hold a few times to retrieve information about the questions raised by the customer (friction point). The agent transfers the call to another team to address the query raised by the customer (friction point). The customer waits in queue again (friction point). The customer has to repeat the question to a new agent (friction point). The agent provides the required information. Finally, the customer hangs up the call. By addressing the Friction Points 204 (or high effort points), the company can significantly reduce customer effort and increase customer acquisition and loyalty. With respect to the aforementioned scenario, the impacted KPI's due to the time, cognitive and emotional effort score are illustrated in TABLE 3.

According to an embodiment herein, consider a telecom company receiving calls from new customers to on-board them. In aforementioned scenario, we need to identify the friction areas and improve the customer experience based on the customer effort score. While measuring CES, denotes that the new callers are effected by time, cognitive and emotional efforts. In the above scenario, following 20 KPI's listed in TABLE 5 are impacted due to time, cognitive and emotional effort score.

TABLE 5

| S. No | Final KPI′ | Definitions | Effort Type | Channel Type |
|---|---|---|---|---|
| 1 | Voice Calls per event | Number of calls received | Cognitive effort | IVR |
| | | for the event | | |
| 2 | Call abandonment at | No. of calls | Cognitive effort & | IVR |
| | IVR | abandoned/Total no. Of | Emotional effort | |
| | | IVR calls made | | |
| 3 | Call abandonment at | No. of calls abandoned/ | Cognitive effort & | ACD |
| | ACD | Total no. Of ACD calls | Emotional effort | |
| | | made | | |
| 4 | IVR Transfer rate | No. of calls transferred to | Cognitive effort | IVR |
| | | ACD/Total no. Of IVR | | |
| | | Calls | | |
| 5 | Avg. IVR talk time | Total time spent from all | Time effort | IVR |
| | | IVR calls/No. Of IVR | | |
| | | calls made | | |
| 6 | Avg. ACD talk time | Total talk time spent from | Time effort | ACD |
| | | all ACD calls/No. Of | | |
| | | ACD calls made | | |
| 7 | IVR Disconnect rate | No. of calls disconnected | Cognitive effort | IVR |
| | | by IVR/Total no. Of IVR | | |
| | | calls made | | |
| 8 | Technical error rate | No. of calls down by | Cognitive effort & | IVR |
| | | linked down error/Total | Emotional effort | |
| | | no. Of IVR calls made | | |
| 9 | Menu path confusion | No. of menu path repeats | Cognitive effort & | IVR |
| | rate | in same call | Emotional effort | |
| 10 | Avg ACD ring time | Total ring time on all | Time effort | ACD |
| | | calls/No. Of ACD calls | | |
| 11 | Avg ACD hold time | Total hold time on all | Time effort & | ACD |
| | | calls/No. Of ACD calls | Emotional effort | |
| 12 | Avg ACD queue time | Total queue time on all | Time effort & | ACD |
| | | calls/No. Of ACD calls | Emotional effort | |
| 13 | Forced disconnect | No. of forced disconnect | Emotional effort | ACD |
| | rate | calls/Total no. Of ACD | | |
| | | calls made | | |
| 14 | ACD Transfer rate | No. of transferred | Emotional effort | ACD |
| | | calls/Total no. of ACD | | |
| | | Calls | | |
| 15 | ACD Conference rate | No. of conference calls | Emotional effort | ACD |
| | | made/Total no. Of ACD | | |
| | | calls | | |
| 16 | Resolution Age | No. of days taken to close | Efficiency metric | Resolution |
| | | the ticket | | |
| 17 | Resolution | Whether received timely | Efficiency metric | Resolution |
| | effectiveness | response fort ticket | | |
| 18 | Resolution touch- | Count of unique touch- | Cognitive effort | IVR, ACD, |
| | points | points on ticket | | Multimedia |
| 19 | CSAT score on | Survey score on customer | Efficiency metric | CSAT |
| | efforts | efforts | | |
| 20 | Interactions per event | No. of interactions across | Cognitive | Multi channel |
| | | all channels made for the | | |
| | | event | | |

According to an embodiment herein, when the CES is higher than a predetermined value, then the enterprise makes operational decisions to make things easier for their customers by creating a separate support team or agents for new (installation in last 30 days) customers and sending emails alerts proactively to help them understand the on-boarding process and reduce their anxiety and thus avoid them calling the support teams.

Thus, the embodiments herein provides benefits including reduction in calls from new customers, reduction in number of tickets logged in first few days of purchase, thus improving productivity, improvement in customer satisfaction score (CSAT).

According to an embodiment herein, consider a scenario of credit card billing dispute with a bank. A customer has a dispute with the billing in his credit card. The customer desires to converse with an agent to understand the billing items and resolve the billing issue. With respect to the aforementioned event, the customer has sent multiple emails, interacted with the agent through web-chat and had multiple conversations with the agent in the past.

Thus, in the aforementioned scenario, the KPI's impacted are illustrated in TABLE 6.

TABLE 6

| | | | | Channel |
|---|---|---|---|---|
| No. | Final KPI′ | Definitions | Effort Type | Type |
| 1 | Voice Calls per event | Number of calls received for | Cognitive effort | IVR |
| | | the event | | |
| 2 | Call abandonment at | No. of calls abandoned/Total | Cognitive effort | IVR |
| | IVR | no. Of IVR calls made | & Emotional | |
| | | | effort | |
| 3 | Call abandonment at | No. of calls abandoned/ | Cognitive effort | ACD |
| | ACD | Total no. Of ACD calls | & Emotional | |
| | | made | effort | |
| 4 | IVR Transfer rate | No. of calls transferred to | Cognitive effort | IVR |
| | | ACD/Total no. Of IVR Calls | | |
| 5 | Avg. IVR talk time | Total time spent from all | Time effort | IVR |
| | | IVR calls/No. Of IVR calls | | |
| | | made | | |
| 6 | Avg. ACD talk time | Total talk time spent from all | Time effort | ACD |
| | | ACD calls/No. Of ACD | | |
| | | calls made | | |
| 7 | IVR Disconnect rate | No. of calls disconnected by | Cognitive effort | IVR |
| | | IVR/Total no. Of IVR calls | | |
| | | made | | |
| 8 | Technical error rate | No. of calls down by linked | Cognitive effort | IVR |
| | | down error/Total no. Of IVR | & Emotional | |
| | | calls made | effort | |
| 9 | Menu path confusion | No. of menu path repeats in | Cognitive effort | IVR |
| | rate | same call | & Emotional | |
| | | | effort | |
| 10 | Avg ACD ring time | Total ring time on all | Time effort | ACD |
| | | calls/No. Of ACD calls | | |
| 11 | Avg ACD hold time | Total hold time on all | Time effort & | ACD |
| | | calls/No. Of ACD calls | Emotional effort | |
| 12 | Avg ACD queue time | Total queue time on all | Time effort & | ACD |
| | | calls/No. Of ACD calls | Emotional effort | |
| 13 | Forced disconnect rate | No. of forced disconnect | Emotional effort | ACD |
| | | calls/Total no. Of ACD calls | | |
| | | made | | |
| 14 | ACD Transfer rate | No. of transferred calls/Total | Emotional effort | ACD |
| | | no. of ACD Calls | | |
| 15 | ACD Conference rate | No. of conference calls | Emotional effort | ACD |
| | | made/Total no. Of ACD | | |
| | | calls | | |
| 16 | Resolution Age | No. of days taken to close | Efficiency metric | Resolution |
| | | the ticket | | |
| 17 | Resolution | Whether received timely | Efficiency metric | Resolution |
| | effectiveness | response fort ticket | | |
| 18 | Resolution touch-points | Count of unique touch-points | Cognitive effort | IVR, ACD, |
| | | on ticket | | Multimedia |
| 19 | Chats per event | No. of chats recorded for the | Cognitive effort | Multimedia |
| | | event | | |
| 20 | Emails per event | No. of emails recorded for | Cognitive effort | Multimedia |
| | | the event | | |
| 21 | Successful chat closure | No. of chats that ended in | Cognitive effort | Multimedia |
| | rate | successful closure/No. Of | & Emotional | |
| | | chats for the event | effort | |
| 22 | Avg chat wait time | Total of chat wait time/No. | Time effort | Multimedia |
| | | Of chats per event | | |
| 23 | Avg mail response time | Total of mail response | Time effort | Multimedia |
| | | time/No. Of mails per event | | |
| 24 | CSAT score on efforts | Survey score on customer | Efficiency metric | CSAT |
| | | efforts | | |
| 25 | Interactions per event | No. of interactions across all | Cognitive | Multi channel |
| | | channels made for the event | | |

According to an embodiment herein, bank need to improve their knowledge base articles. Further, the bank makes a proactive contact and resolve the issue. Thus, utilising the customer effort architecture the bank achieves reduction in contact rates for billing dispute callers, and reduces unresolved disputes. Further, the bank reduces the number of calls during the billing/payment cycle and improves CSAT score.

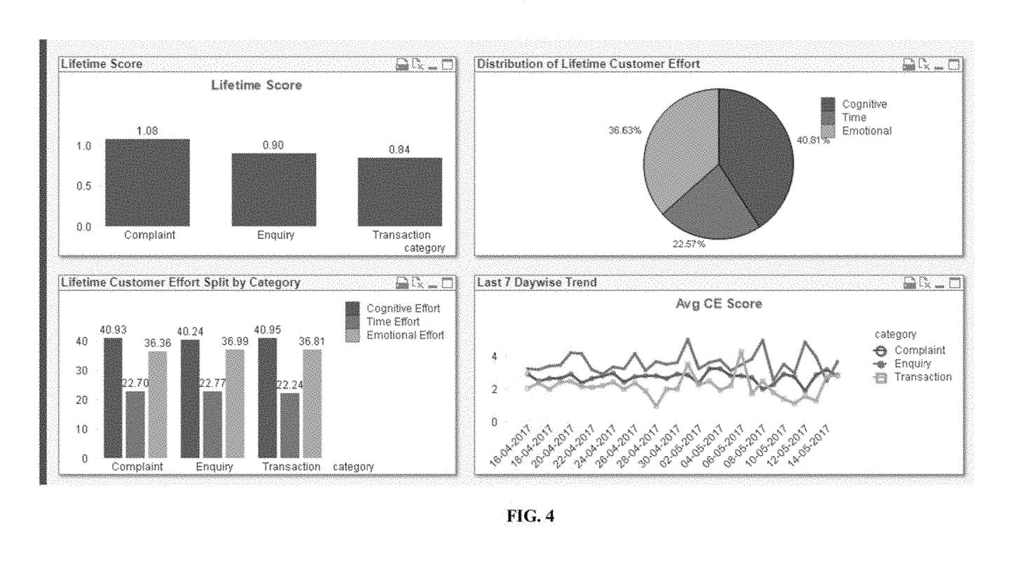

FIG. 4 is an exemplary illustration of a user interface displaying average day wise customer effort score calculated for a set of data. In an example, the plurality of data categories such as complaint, enquiry, and transaction category are selected for determining customer effort score. Further, a distribution of lifetime customer effort is displayed along with day wise customer effort score calculated for each category.

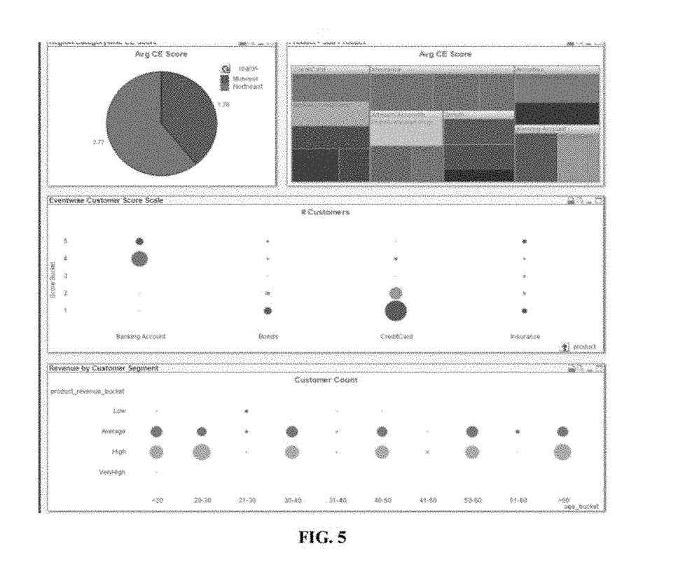

FIG. 5 is an exemplary illustration of a user interface displaying event wise customer effort and revenue by customer segment. In an example, the average customer effort score based on different regions is displayed.

These and other aspects of the embodiment herein will be better appreciated and understood when considered in conjunction with the following description and the accompanying drawings. It should be understood, however, that the following descriptions, while indicating the preferred embodiments and numerous specific details thereof, are given by way of an illustration and not of a limitation. Many changes and modifications may be made within the scope of the embodiments herein without departing from the spirit thereof, and the embodiments herein include all such modifications.

The customer effort architecture that estimates customer effort, identifies the friction points and processes leading to excessive customer effort. Further, the customer effort architecture ensures that the processes leading to excessive customer effort are eliminated. The customer effort architecture enables a bank to reduce contact rates for billing dispute callers, and reduces unresolved disputes. Further, the bank reduces the number of calls during the billing/payment cycle and improves CSAT score. In a telecom company, customer effort architecture enables to reduce incoming calls from new customers, and reduces number of tickets logged in first few days of purchase.

The foregoing description of the specific embodiments will so fully reveal the general nature of the disclosures herein that others can, by applying current knowledge, readily modify and/or adapt for various applications such specific embodiments without departing from the generic concept, and, therefore, such adaptations and modifications should and are intended to be comprehended within the meaning and range of equivalents of the disclosed embodiments.

It is to be understood that the phraseology or terminology employed herein is for the purpose of description and not of limitation. Therefore, while the embodiments herein have been described in terms of preferred embodiments, those skilled in the art will recognize that the embodiments herein can be practiced with modifications.

What is claimed is:

1. A method for measuring customer effort score using Customer Effort architecture, the method comprising:
receiving data from a plurality of data sources by a data collector;
storing the received data in a data repository;
assigning pre-defined weights to the plurality of data sources for calculating customer effort score by an analytics engine;
assigning user defined criteria to the plurality of data sources by the analytics engine, wherein the user defined criteria comprises at least one of life cycle, day wise, customer effort on events, customer efforts on loyalty, and customer effort based on last transaction;
analysing the plurality of data sources using pre-set computing scripts and preset rules by the analytics engine;
segmenting the plurality of data sources into one of an emotional effort, a time effort and a cognitive effort by the analytics engine; and
determining customer effort score by the analytics engine based on a pre-determined formula and the applied weights.

2. The method as claimed in claim 1, wherein the step of analysing the plurality of data sources comprises:
performing reference level check for the plurality of data sources;
normalising each data value from the plurality of data sources to a maximum value and a minimum value;
performing time interval spacing for the plurality of data sources; and
scaling the plurality of data sources with respect to the reference segments measured on categories comprising region and product.

3. The method as claimed in claim 1, wherein the step of segmenting data further comprises segmenting data sources based on at least one of such as age, income, and product revenue.

4. The method as claimed in claim 1, further comprises storing computed customer effort score in a data repository/storage; and accessing the computed customer effort score from a user interface of an application program.

5. The method as claimed in claim 1, wherein the plurality of data sources segmented as cognitive effort comprises voice call per event, Call abandonment at IVR, Call abandonment at ACD, IVR Transfer rate, IVR Disconnect rate, Technical error rate, Menu path confusion rate, Resolution touch-points, Chats per event, Emails per event, Successful chat closure rate, Web query rate, Web error rate, and Interactions per event.

6. The method as claimed in claim 1, wherein the plurality of data sources segmented as time effort comprises average IVR talk time, average ACD talk time, average ACD ring time, average ACD hold time, average ACD queue time, average chat wait time, and average mail response time.

7. The method as claimed in claim 1, wherein the plurality of data sources segmented as emotional effort comprises call abandonment at IVR, call abandonment at ACD, technical error rate, menu path confusion rate, average ACD hold time, average ACD queue time, forced disconnect rate, ACD Transfer rate, ACD Conference rate, successful chat closure rate, and web error rate.

8. A computer system for measuring customer effort score, the system comprising:
a hardware processor coupled to a memory containing instructions configured for computing customer effort score while using web services;
a display screen coupled to the hardware processor for providing a user interface on a computing device;
a data collector configured to receive a plurality of data from a plurality of data sources;
a data repository configured to store the plurality of data sources; and
an analytics engine configured to assign pre-defined weights to the plurality of data sources for calculating customer effort score, and wherein the analytics engine is configured to assign user defined criteria to the plurality of data and wherein the analytics engine is configured to analyse the plurality of data sources using pre-set computing scripts, and wherein the analytics engine is configured to segment the plurality of data sources into emotional effort, time effort and cognitive effort by the analytics engine, and wherein the analytics engine is configured to determine customer effort score based on a pre-determined formula and the applied weights, and wherein the analytics engine is further configured to store computed customer effort score in a data repository/storage and access the computed customer effort score from a user interface of an application program.

9. The system as claimed in claim 8, wherein the analytics engine is further configured to:
perform reference level check for the plurality of data sources;
normalise each data value from the plurality of data sources to a maximum value and a minimum value;
perform a time interval spacing for the plurality of data sources; and
scale the plurality of data sources with respect to the reference segments measured on categories comprising region and product.

10. The system as claimed in claim 8, wherein the analytics engine is further configured to
segment data sources based on at least one of such as age, income, and product revenue.

11. The system as claimed in claim 8, wherein the plurality of data sources segmented as cognitive effort comprises voice call per event, Call abandonment at IVR, Call abandonment at ACD, IVR Transfer rate, IVR Disconnect rate, Technical error rate, Menu path confusion rate, Resolution touch-points, Chats per event, Emails per event, Successful chat closure rate, Web query rate, Web error rate, and Interactions per event.

12. The system as claimed in claim 8, wherein the plurality of data sources segmented as time effort comprises average IVR talk time, average ACD talk time, average ACD ring time, average ACD hold time, average ACD queue time, average chat wait time, and average mail response time.

13. The system as claimed in claim 8, wherein the plurality of data sources segmented as emotional effort comprises call abandonment at IVR, call abandonment at ACD, technical error rate, menu path confusion rate, average ACD hold time, average ACD queue time, forced disconnect rate, ACD Transfer rate, ACD Conference rate, successful chat closure rate, and web error rate.

14. A computer implemented method comprising instructions stored on a non-transitory computer readable storage medium and are executed on a hard ware processor of a computing device comprising a processor and a memory for measuring customer effort score, the method comprising the steps of:
receiving a data from a plurality of data sources by a data collector,
storing the received data in a data repository;
assigning pre-defined weights to the plurality of data for calculating customer effort score;
assigning user defined criteria to the plurality of data sources, wherein the user defined criteria comprises at least one of life cycle, day wise, customer effort on events, customer efforts on loyalty, and customer effort based on last transaction;
analysing the plurality of data sources using pre-set computing scripts;
segmenting the plurality of data sources into one of an emotional effort, a time effort and a cognitive effort by the analytics engine; and
determining a customer effort score by the analytics engine based on a pre-determined formula and the applied weights.

15. The method as claimed in claim 14, wherein the step of analysing the plurality of data sources comprises:
performing reference level check for the plurality of data sources;
normalising each data value from the plurality of data sources to a maximum value and a minimum value;
performing time interval spacing for the plurality of data sources; and
scaling the plurality of data sources with respect to the reference segments measured on categories comprising region and product.

16. The method as claimed in claim 14, wherein the step of segmenting data further comprises segmenting data sources based on at least one of such as age, income, and product revenue.

17. The method as claimed in claim 14, further comprises storing computed customer effort score in a data repository/storage; and accessing the computed customer effort score from a user interface of an application program.

18. The method as claimed in claim 14, wherein the plurality of data sources segmented as cognitive effort comprises voice call per event, Call abandonment at IVR, Call abandonment at ACD, IVR Transfer rate, IVR Disconnect rate, Technical error rate, Menu path confusion rate, Resolution touch-points, Chats per event, Emails per event, Successful chat closure rate, Web query rate, Web error rate, and Interactions per event.

19. The method as claimed in claim 14, wherein the plurality of data sources segmented as time effort comprises average IVR talk time, average ACD talk time, average ACD ring time, average ACD hold time, average ACD queue time, average chat wait time, and average mail response time.

20. The method as claimed in claim 14, wherein the plurality of data sources segmented as emotional effort comprises call abandonment at IVR, call abandonment at ACD, technical error rate, menu path confusion rate, average ACD hold time, average ACD queue time, forced disconnect rate, ACD Transfer rate, ACD Conference rate, successful chat closure rate, and web error rate.
